(19) United States
(12) Patent Application Publication
(10) Pub. No.: US 2009/0097946 A1
(43) Pub. Date: Apr. 16, 2009

(54) BINDING APPARATUS, SHEET FINISHER AND IMAGE FORMING SYSTEM

(76) Inventor: Tomoya MOTOYOSHI, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/248,614

(22) Filed: Oct. 9, 2008

(30) Foreign Application Priority Data
Oct. 12, 2007 (JP) 2007-266697

(51) Int. Cl. B42C 9/00; B65H 39/00; G03G 15/22

(52) U.S. Cl. 412/37; 270/58.11; 399/130

(57) ABSTRACT

Disclosed is a binding apparatus including: a booklet producing section to produce a booklet by performing pasting onto a side face of a bundle of papers; a roughening section to perform roughening processing to one end part to which the pasting to the papers is performed; and a controlling section to judge whether the roughening processing by the roughening section is necessary or not based on a type of the paper before causing the booklet producing section to produce the booklet, and to cause the roughening section to execute the roughening processing to the paper when the controlling section judges that the roughening processing is necessary.

### BACKGROUND OF THE INVENTION

1. Field of the Invention

The present invention relates to a binding apparatus, a sheet finisher, and an image forming system.

2. Description of Related Art

In recent years, there has been a binding apparatus to execute binding processing for producing a booklet by performing binding with staples or pasting to a paper bundle heaping papers on which images have been formed. The binding apparatus to produce a booklet by pasting applies an adhesive to one end part of a paper bundle uniformly to bond papers mutually. Then, the binding apparatus bonds the paper bundle with a cover to produce a booklet.

Japanese Patent Application Laid-Open Publication No. 2007-62145 discloses, for example, a binding apparatus provided with a notch forming section to form a notch part on the end side of each of papers on which a paste is applied at the time of the binding processing of the papers as a technique of the processing (roughening processing) for improving the strength of the booklet (binding) produced by increasing the bonding area of the paste applied to the one end part of the paper bundle in the aforesaid binding apparatus.

However, because the aforesaid conventional binding apparatus performs the roughening processing to form the notch part to all papers constituting the paper bundle, a large amount of adhesive is led to be applied to the papers that the adhesive permeates well, and consequently the waste of the adhesive, unnecessary scraps, and an originally unnecessary processing time are generated. Moreover, if a user forgot to perform the setting of roughening processing, then it is apprehended that a booklet having weak binding strength owing to insufficient bonding forces between mutual papers is formed with some types of paper.

### SUMMARY OF THE INVENTION

According to a first aspect of the present invention, there is provided a binding apparatus including: a booklet producing section to produce a booklet by performing pasting onto a side face of a bundle of papers; a roughening section to perform roughening processing to one end part to which the pasting to the papers is performed; and a controlling section to judge whether the roughening processing by the roughening section is necessary or not based on a type of the paper before causing the booklet producing section to produce the booklet, and to cause the roughening section to execute the roughening processing to the paper when the controlling section judges that the roughening processing is necessary.

According to a second aspect of the present invention, there is provided a sheet finisher to perform post-processing to papers, the apparatus including the binding apparatus.

According to a third aspect of the present invention, there is provided an image forming system including an image forming apparatus to form images on papers and the binding apparatus to perform binding processing to papers on which the images are formed by the image forming apparatus.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a sectional configuration view of an image forming system including an image forming apparatus and a sheet finisher;

FIG. 2 is a view showing an example of a binding setting screen;

FIG. 3 is a block diagram showing the functional configuration of the image forming system;

FIG. 4 is the main flow chart of roughening executing processing in a first embodiment;

FIG. 5 is a flow chart of paper type judging processing;

FIG. 6 is the main flow chart of roughening executing processing in a second embodiment;

FIG. 7 is a flow chart of roughening executing processing in a third embodiment;

FIG. 8A is an image view of the papers indicating judgment results judged by paper type judging processing based on the paper information of each paper;

FIG. 8B is an image view of each paper constituting a bundle of papers after execution of the roughening executing processing in the third embodiment;

FIG. 9 is a flow chart of roughening executing processing in a fourth embodiment;

FIG. 10 is another flow chart (the continuation of the roughening executing processing of FIG. 9) of the roughening executing processing in the fourth embodiment;

FIG. 11A is an image view of the papers indicating judgment results judged by paper type judging processing based on the paper information of each paper; and

FIG. 11B is an image view of each paper constituting a bundle of papers after execution of the roughening executing processing in the fourth embodiment.

### DESCRIPTION OF THE PREFERRED EMBODIMENTS

### First Embodiment

In the following, a first embodiment of the present invention will be described in detail with reference to the attached drawings.

First, the configuration thereof is described.

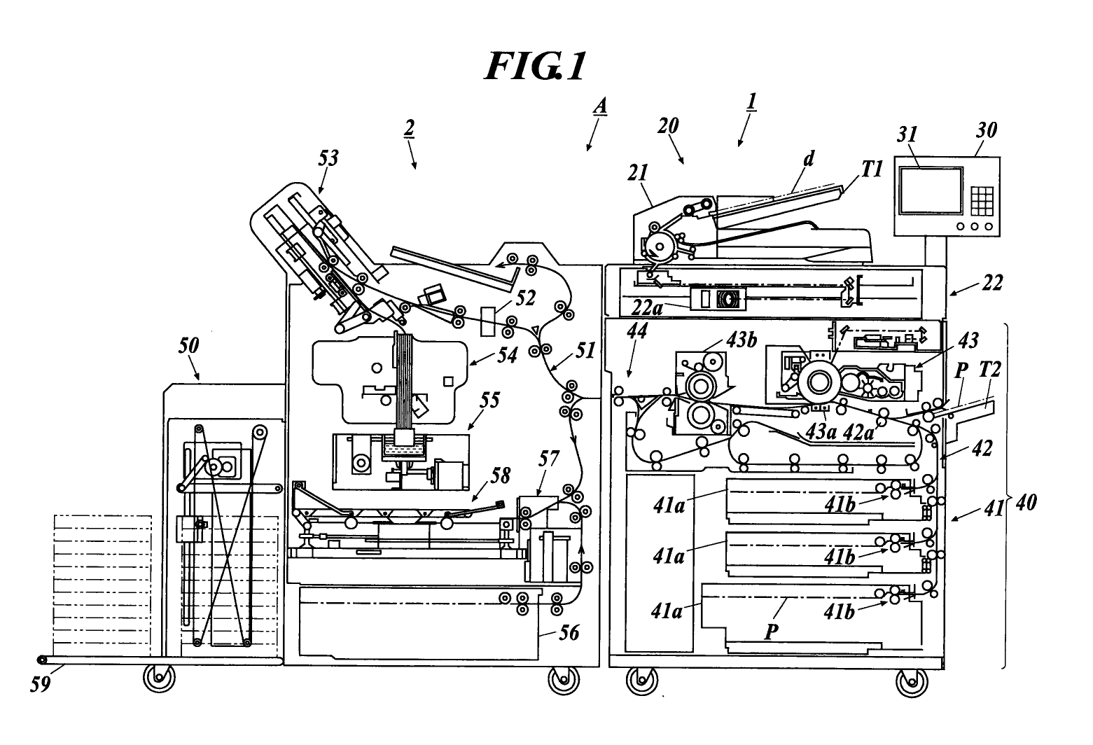

FIG. 1 shows a sectional configuration view of an image forming system A equipped with an image forming apparatus 1 and a sheet finisher 2.

As shown in FIG. 1, the image forming system A is a digital multifunction peripheral equipped with the image forming apparatus 1 and the sheet finisher 2. The image forming apparatus 1 sometimes reads an image from an original and performs the image formation of the read image on a paper P. The image forming apparatus 1 sometimes receives a job including page data containing image data, an image forming condition of each piece of image data, and the like, from an external apparatus or the like, and forms an image on a paper P based on the received job. The sheet finisher 2 performs post-processing to papers on which images are formed. As shown in FIG. 1, the image forming apparatus 1 is composed of an image reading section 20, an operation displaying section 30, a printing section 40, and the like.

The image reading section 20 is equipped with an automatic original feeding section 21 called as an auto document feeder (ADF) and a reading section 22.

The automatic original feeding section 21 automatically delivers the originals set on an original tray T1 onto the platen glass of the reading section 22 one by one.

The reading section 22 is composed of the platen glass, a charge coupled device (CCD) 22a, a light source, and the like, and reads the image of an original by performing the image formation of the reflected lights of the lights that have been radiated from the light source to the original and have scanned the original with the CCD 22a to perform the photoelectric conversion of the formed image. Then, the image (analog image signal) read by the reading section 22 receives an analogue to digital conversion and various kinds of image processing, following which the image is output to the printing section 40 as print data. The image means to include not only the image data of figures, photographs, and the like, but also text data of characters, marks, and the like, here.

The operation displaying section 30 is composed of a liquid crystal display (LCD), a touch panel 31 provided so as to cover the LCD, another operation key group, and the like. The operation displaying section 30 receives a user's input and outputs the input information to a body controlling section 100, which will be described later. Moreover, the operation displaying section 30 displays various setting screens, various processing results, and the like, for inputting various setting conditions in accordance with display signals input from the body controlling section 100.

A binding setting screen and a screen for receiving an input instruction of the type of the paper to be processed by roughening processing are displayed on the touch panel 31 of the operation displaying section 30. The binding setting screen is a screen for receiving an input instruction about whether to perform the setting of the binding strength of a booklet or not, that is, whether to perform the processing (roughening processing) to enhance the permeability of a paste to one end parts of the papers constituting a bundle of papers or not, or whether to perform the roughening processing to all papers or not, at the time of executing binding processing to produce the booklet by performing the pasting of a side face of the bundle of papers in the sheet finisher 2. The operation displaying section 30 outputs an operation signal indicating an instruction received on the screen to a body controlling section 100. Consequently, the operation displaying section 30 having the touch panel 31 realizes a paper type setting section (first setting section) and a roughening executing setting section (second setting section).

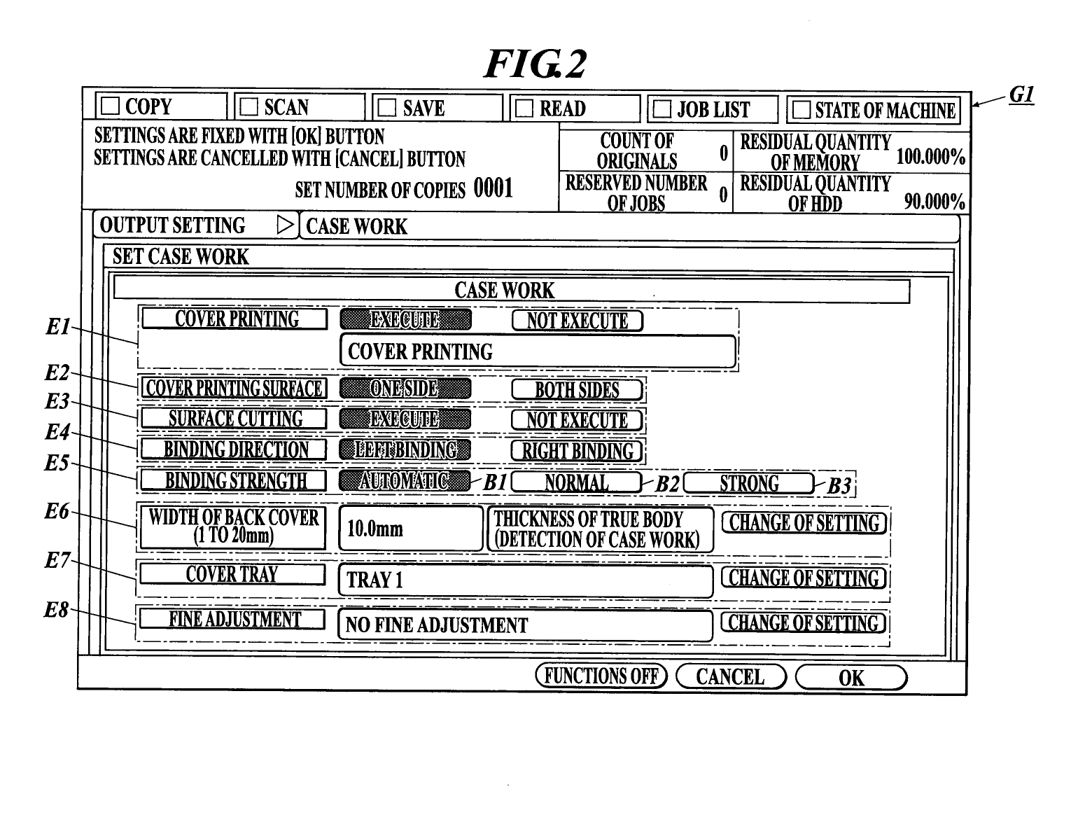

FIG. 2 shows an example of a binding setting screen G1.

The binding setting screen G1 shown in FIG. 2 is a screen for receiving setting instructions of various conditions at the time of executing the binding processing to be executed by the binding apparatus equipped in the sheet finisher 2, and includes a cover printing setting region E1, a cover printing surface setting region E2, a cover cutting setting region E3, a binding direction setting region E4, a binding strength setting region E5, a back cover width setting region E6, a cover tray setting region E7, a fine adjustment setting region E8, and the like.

The binding strength setting region E5 is equipped with an automatic button B1 to perform roughening executing processing, which will be described later, in the present first embodiment to set the binding strength to that produced by the processing, a normal button B2 to set the binding strength to that at the time of performing no roughening executing processing, and a strong button B3 to set the binding strength to that caused by performing the roughening processing to all papers constituting a bundle of papers.

That is, the binding strength of a booklet produced by the binding apparatus becomes the strength setting under which the strength is weakest when the normal button B2 is depressed; the strength is strongest when the strong button B3 is depressed; and the strength when the automatic button B1 is depressed is stronger than that when the normal button B2 is depressed and is weaker than that when the strong button B3 is depressed.

The printing section 40 performs image formation processing of the electrophotographic printing system based on input print data, and is composed of a paper feeding section 41, a paper feeding and conveying section 42, an image forming section 43, and a carrying-out section 44.

The paper feeding section 41 is equipped with a plurality of paper feeding trays 41a, paper feeding measures 41b, a manual tray T2, and the like. Each of the paper feeding trays 41a houses a previously respectively identified type of papers P, which are conveyed toward the feeding and conveying section 42 by the paper feeding measures 41b from the uppermost sheet one by one. The manual tray T2 can be loaded with various types of paper P in accordance with the needs of a user, and conveys the papers P that have been loaded by feed rollers toward the paper feeding and conveying section 42 from the uppermost sheet one by one.

The paper feeding and conveying section 42 conveys the papers P conveyed from the paper feeding trays 41a or the manual tray T2 to a transferring apparatus 43a through a plurality of intermediate rollers, resist rollers 42a, and the like.

Moreover, the paper feeding and conveying section 42 conveys a paper P on one side of which image formation processing has been performed to the both side conveyance path of the conveying section 42 with the conveyance path switching plate thereof and conveys the paper P to the transferring apparatus 43a through the intermediate rollers and the resist rollers 42a again.

The image forming section 43 is equipped with a photosensitive drum, a charging apparatus, an exposure apparatus including a laser light outputting section to output a laser light based on image data and a polygon mirror to perform scanning in the main scanning direction with the laser light, a development apparatus, the transferring apparatus 43a, a cleaning section, and a fixing apparatus 43b. To put it concretely, the image forming section 43 forms an electrostatic latent image by radiating a laser light with the exposure apparatus to the photosensitive drum charged by the charging apparatus. Then, the development apparatus develops the electrostatic latent image by adhering charged toner to the surface of the photosensitive drum, on which the electrostatic latent image is formed. The toner image formed on the photosensitive drum by the development apparatus is transferred onto the paper P by the transferring apparatus 43a. Moreover, after the transferring of the toner image onto the paper P, residual toner and the like on the surface of the photosensitive drum is removed by the cleaning section.

The fixing apparatus 43b performs the heat fixing of the toner image transferred onto the paper P conveyed by the paper feeding and conveying section 42. The paper P having received the fixing processing is put between the paper ejecting rollers of the carrying-out section 44 to be conveyed from a carrying-out port to the sheet finisher 2.

The sheet finisher 2 is composed of an apparatus for performing post-processing to paper such as a binding apparatus 50, paper ejecting rollers to convey the papers carried out from the image forming apparatus 1 to a predetermined apparatus along a conveyance pathway and to eject the paper to a predetermined catch tray, and the like.

The binding apparatus 50 is one to produce a booklet by performing pasting by applying, for example, a thermally fused paste to a side face of a bundle of papers. The binding apparatus 50 is equipped with a conveying section 51, a roughening section 52, a reversing section 53, a paper bundle housing section 54, an applying section 55, a cover supplying section 56, a cutting section 57, a booklet forming section 58, a booklet housing tray 59, and the like.

The conveying section 51 includes a plurality of conveyance rollers, and puts a paper conveyed from the image forming apparatus 1 between the rollers to convey the paper to the roughening section 52, the reversing section 53, and the paper bundle housing section 54, or to the cutting section 57 and the booklet forming section 58.

The roughening section 52 functions as a roughening section to perform the processing of enhancing the permeability of the paste to one end part of paper (roughening processing), and is composed of, for example, a die fixedly mounted on a paper conveyance pathway, a punch to ascend and descend to be fitted to the die, a driving section to make the punch ascend and descend, a scrap housing section to house paper scraps cut by the punch, and the like. The roughening section 52 performs roughening processing by forming a notch part in the one end part of a paper by the fitting of the die and the punch. Incidentally, a semicircle, a V configuration, a U configuration, and the like, can be listed as the shape of the notch part.

The reversing section 53 is composed of a paper loading stand arranged to be inclined, a rockable locating member to locate the rear end of a paper, an adjusting member to adjust the paper in the paper width direction, and the like, and houses the paper conveyed from the conveying section 51 in the paper loading stand.

The location of the paper interchanging of the paper placed on the paper loading stand of the reversing section 53 is performed by the rocking of the locating member. Moreover, after the adjustment of the paper width has been performed by the adjusting member, the paper is ejected obliquely downward, and the paper is sequentially housed into the paper bundle housing section 54 to be heaped therein.

The paper bundle housing section 54 is composed of a supporting member having an inclined heaping surface, a rockable receiving plate, a longitudinal adjusting member, a lateral adjusting member, a depressing member, and the like.

A paper that has descended from the reversing section 53 slides down the heaping surface of the supporting member, and then the apical part of the paper comes into contact with the receiving plate to stop. The longitudinal adjusting member depresses the rear end part of the papers placed on the supporting member according to the size of the papers and makes the apical parts of the papers come into contact with the receiving plate to perform their longitudinal adjustments for aligning the leading edges of the papers. Moreover, the lateral adjusting member depresses the side edges of the papers to be housed to perform their lateral adjustments in their paper width directions.

That is, the paper sequentially ejected from the image forming apparatus 1 receive switchback conveyance in the reversing section 53, and are heaped in the paper bundle housing section 54. Then, their longitudinal adjustments and lateral adjustments are performed, and a paper bundle composed of a plurality of papers is formed.

When the paper bundle is formed, the paper bundle is depressed in the thickness direction to be nipped by the depressing member, and the paper bundle is held in the state corresponding to the applying section 55 from its inclined state.

The applying section 55 is composed of an applying roller, a driving section to perform the rotation driving of the applying roller, a receptacle to house an adhesive, such as a paste, a moving member capable of moving the receptacle to the application position of the adhesive while supporting the receptacle, a moving section to move the moving member, a heating member to heat the adhesive housed in the receptacle, and the like.

The applying roller soaked in the receptacle, which houses the adhesive, is rotated, and the adhesive is applied onto the surface of the paper bundle opposed to the receptacle by the movement of the moving member.

The cover supplying section 56 is composed of a cover loading section housing papers to be covers, a paper feeding section, and the like, and a cover housed in the cover loading section is conveyed to the booklet forming section 58 by the paper feeding section.

The cutting section 57 is equipped with a rotary cutter composed of a rotary knife and a stationary knife, and cuts the cover so that the conveyance direction length thereof may be a predetermined length. The predetermined length is, for example, a length of adding the thickness of the paper bundle to the doubles of the length of the short side of the paper bundle when the case work processing is performed by bonding the cover to the back of the paper bundle.

The booklet forming section 58 is composed of a plurality of conveyance rollers to receive a cover conveyed from the cover supplying section 56 to convey the cover to a predetermined position, a pressurizing member to contact the cover with the adhesive applying surface of a paper bundle by pressuring the cover to the surface, a moving housing to support the plurality of conveyance rollers and the pressurizing member, an adjusting section, an ascending and descending section to move the moving housing into vertically up-and-down directions, and the like.

The width adjustment of a cover conveyed from the cover supplying section 56 to the booklet forming section 58 is performed by depressing both the side faces of the cover in the width direction thereof by the adjusting section according to the size of the cover. Then, the adjusted cover is switched back, and is conveyed to the cutting section 57 to be cut. Furthermore, the cover is again conveyed to the booklet forming section 58, and the width adjustment by the adjusting section is performed. After that, the cover is raised to a predetermined position, and the central part of the cover placed on the pressurizing member is contacted with the adhesive applying surface of the paper bundle by pressuring the central part to the adhesive applying surface. Thus the cover is bonded to the adhesive applying surface.

After that, the cover is bent along the side edge of the adhesive applying surface of the paper bundle, and a front cover and a back cover are superposed on the front surface and back surface of the paper bundle, respectively, to form a booklet. The formed booklet is conveyed to a booklet housing tray, and is loaded on the booklet housing tray to be housed.

As described above, the booklet producing section to produce a booklet by performing pasting to the side face of the bundle of papers is composed of the conveying section 51, the reversing section 53, the paper bundle housing section 54, the applying section 55, the cover supplying section 56, the cutting section 57, and the booklet forming section 58.

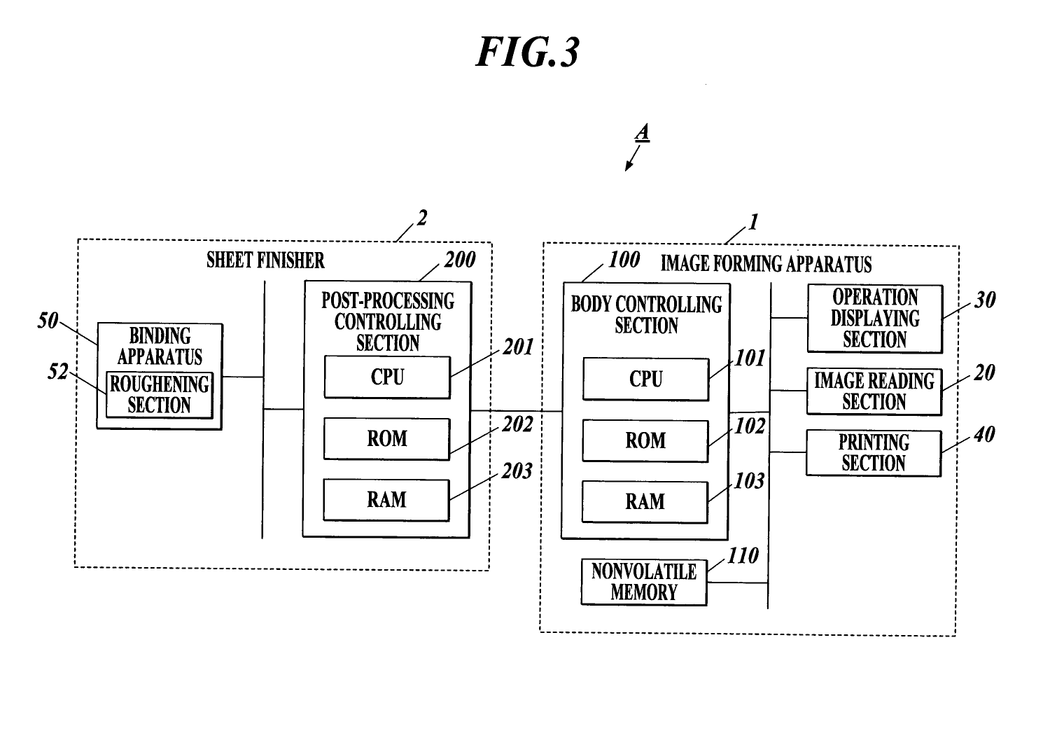

FIG. 3 shows a block diagram showing the functional configuration of the image forming system A.

As shown in FIG. 3, the image forming system A is composed of the image forming apparatus 1 and the sheet finisher 2 connected to the image forming apparatus 1.

The image forming apparatus 1 is composed of the body controlling section 100, a nonvolatile memory 110, the image reading section 20, and the operation displaying section 30. Incidentally, the same components as those described with reference to FIG. 1 are denoted by the same marks as those in FIG. 1, and their descriptions are omitted.

The body controlling section 100 is composed of a central processing unit (CPU) 101, a read only memory (ROM) 102, a random access memory (RAM) 103, and the like.

The CPU 101 reads the system program and a designated program among various application programs stored in the ROM 102 to expand them in RAM 103, and executes various kinds of processing in cooperation with the programs expanded in the RAM 103 to perform the integrated control of each section of the image forming apparatus 1.

The ROM 102 stores the system program executable in the image forming apparatus 1, various processing programs executable on the system program, data to be used at the time of the execution of these various processing programs, data of the processing results of arithmetic processing by the CPU 101, and the like. Incidentally, the programs are stored in the forms of program codes readable by a computer.

The RAM 103 is equipped with a program storing region for the CPU 101 to expand the processing program to execute and the like, and a data storing region for the CPU 101 to store input data, the processing results to be generated at the time of the execution of the processing program, and the like.

Moreover, the body controlling section 100 transmits the information pertaining to the sheet finisher 2, such as the paper information of the paper ejected to the sheet finisher 2, the setting information of the binding strength received by the operation displaying section 30, and the information of the paper type to which roughening processing is performed, to the sheet finisher 2 in cooperation with the CPU 101, the ROM 102, and the RAM 103. The paper information includes the information indicating the type of paper, such as plain paper, thick paper, colored paper, fine quality paper, glossy paper, or coated paper, and the information indicating what number of paper constituting a bundle of papers is in the bundle of papers to which the paper belongs.

The nonvolatile memory 110 is configured of a semiconductor memory or the like capable of reading and writing data, and stores various kinds of setting data pertaining to the image forming apparatus 1, and the like.

The sheet finisher 2 is composed of a post-processing controlling section 200, the binding apparatus 50 including the roughening section 52, and the like. Incidentally, the same components as those described with reference to FIG. 1 are denoted by the same marks as those in FIG. 1, and their descriptions are omitted.

The post-processing controlling section 200 is composed of a CPU 201, a ROM 202, a RAM 203, and the like.

The CPU 201 reads the various processing programs of the sheet finisher 2 stored in the ROM 202 to expand the read programs in the RAM 203, and executes various kinds of processing in cooperation with the programs expanded in the RAM 203 to control each section of the sheet finisher 2.

The ROM 202 stores various processing programs executable in the sheet finisher 2, the roughening executing processing program in the present first embodiment, the data to be used at the time of the execution of these various processing programs, the data of the processing results of arithmetic processing by the CPU 201, and the like. Incidentally, the programs are stored in the forms of program codes readable by a computer.

Moreover, the ROM 202 realizes the function as a storage section to previously store the types of papers (hereinafter referred to as registered roughening needing paper) to receive roughening processing by the roughening section. The types of the paper to receive the roughening processing are those of the paper having low permeability of paste, such as the colored paper, the fine quality paper, the glossy paper, and the coated paper.

The RAM 203 includes a program storing region for the CPU 201 to expand the processing program to execute, a data storing region to store input data, the processing results generated at the time of the execution of the processing program, and the like, and a region to store various kinds of information, such as the paper information transmitted from the image forming apparatus 1, the setting information of binding strength, the information of the type of paper that receives roughening processing (specified roughening needing paper), and the like.

Moreover, the post-processing controlling section 200 reads the roughening executing processing program according to the present first embodiment from the ROM 202, and reads various kinds of information, such as paper information and the setting information of binding strength received by the operation displaying section 30, from the RAM 203. If the automatic button B1 is depressed as the binding strength, then the post-processing controlling section 200 judges whether the roughening processing by the roughening section 52 is necessary for a conveyed paper or not by the registered roughening needing paper stored in the ROM 202 or by the specified roughening needing paper stored in the RAM 203 based on the type of the paper before producing a booklet. The post-processing controlling section 200 realizes the function as a controlling section for executing the roughening processing to the paper based on the judgment result.

Next, the operation of the present first embodiment is described.

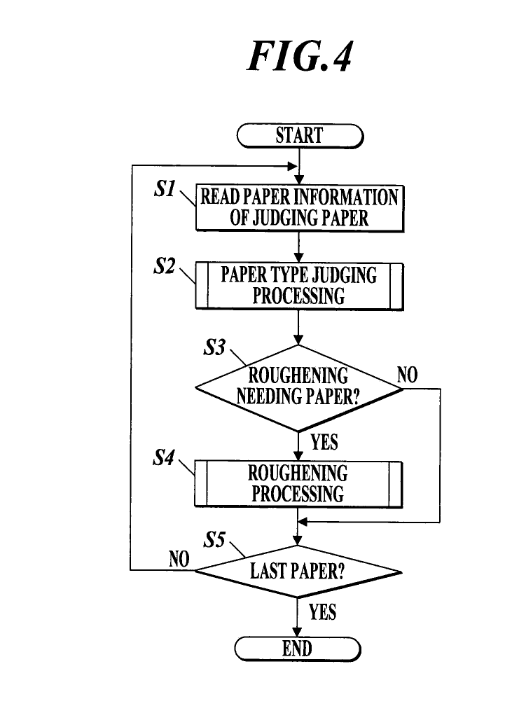

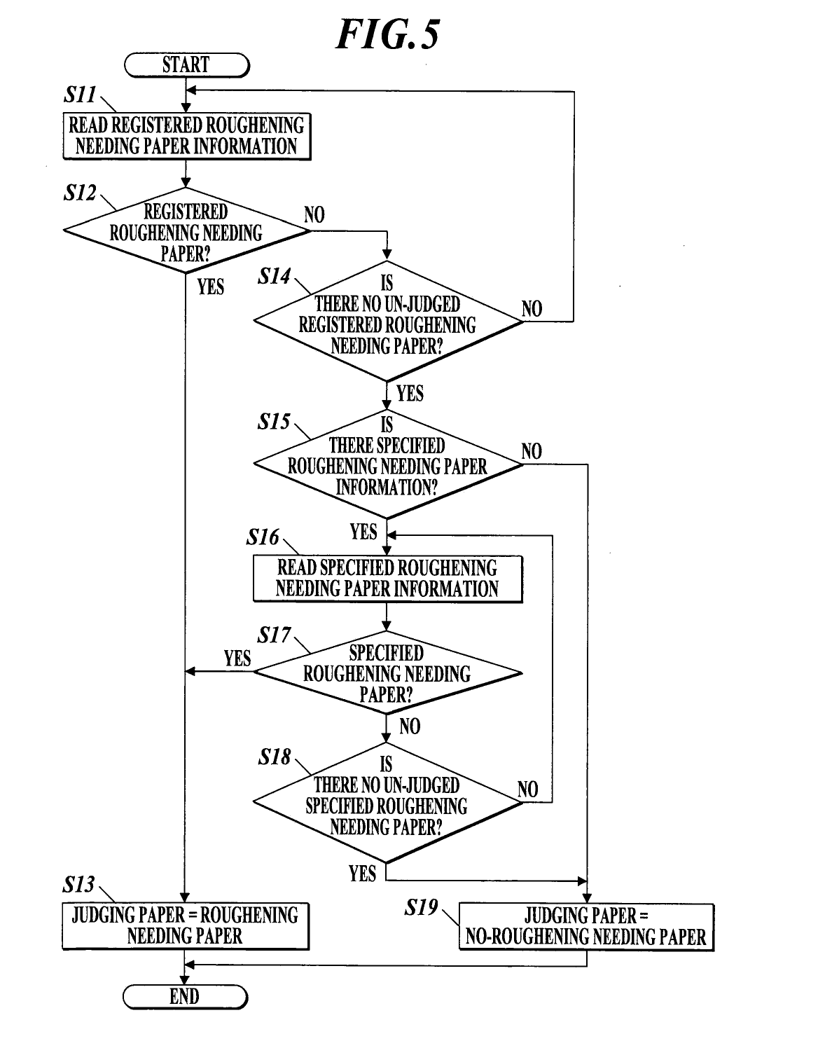

FIGS. 4 and 5 show the flow charts of the roughening executing processing of the present first embodiment. FIG. 4 shows the main flow chart of the roughening executing processing. Incidentally, it is supposed that the flow chart shown in FIG. 4 indicates the processing executed every formed booklet unit by the post-processing controlling section 200.

The post-processing controlling section 200 reads the paper information of a paper (hereinafter referred to as judging paper) having reached a carry-in port, through which papers are conveyed from the image forming apparatus 1, from the RAM 203 based on a signal from a sensor provided at the carry-in port (Step S1), and executes the paper type judging processing to the judging paper (Step S2).

The post-processing controlling section 200 judges whether the judging paper is the paper (first paper) judged that the roughening processing by the roughening section 52 is necessary (hereinafter referred to as roughening needing paper) or not (Step S3). If the judging paper is not the roughening needing paper (Step S3; No), then the post-processing controlling section 200 advance its processing to Step S5.

If the judging paper is the roughening needing paper (Step S3; Yes), then the post-processing controlling section 200 drives the roughening section 52 to perform the roughening processing to the judging paper (Step S4), and advances the processing to Step S5.

After the judgment result of No at Step S3 or after the processing at Step S4, the post-processing controlling section 200 judges whether the judging paper is the last paper or not among a plurality of papers constituting the bundle of papers (Step S5). If the judging paper is not the last paper (Step S5; No), then the post-processing controlling section 200 returns the processing to Step S1. If the judging paper is the last paper (Step S5; Yes), the post-processing controlling section 200 ends the present processing.

FIG. 5 shows the flow chart of the paper type judging processing in the main flow chart of the roughening executing processing shown in FIG. 4. Incidentally, it is supposed that the flow chart shown in FIG. 5 is the processing to be executed by the post-processing controlling section 200.

The post-processing controlling section 200 reads the information of the registered roughening needing paper from the ROM 202 (Step S11), and judges whether the judging paper is the registered roughening needing paper or not (Step S12).

If the judging paper is the registered roughening needing paper (Step S12; Yes), then the post-processing controlling section 200 sets the judging paper to be the roughening needing paper (Step S13), and ends the present processing. Consequently, the roughening processing can be executed to the prestored paper of the type of being an object of the roughening processing (registered roughening needing paper).

If the judging paper is not the registered roughening needing paper (Step S12; No), then the post-processing controlling section 200 judges whether no un-judged registered roughening needing paper exists or not (Step S14). If any un-judged registered roughening needing paper exists (Step S14; No), then the post-processing controlling section 200 returns the processing to Step S11.

In the processing of Steps S11-S14, for example, if colored paper, fine quality paper, glossy paper, and coated paper are set as the registered roughening needing paper, then the post-processing controlling section 200 judges whether the type of the paper read at Step S11 among the plurality of paper types set as the registered roughening needing paper is coincident with the paper type of the judging paper or not. If both the paper types are coincident with each other, then the post-processing controlling section 200 judges that the judging paper is the registered roughening needing paper. If both the paper types are not coincident with each other, then the post-processing controlling section 200 returns the processing to Step S11, and reads another type of the paper set as the registered roughening needing paper to perform the comparison again.

If there is no un-judged registered roughening needing paper (Step S14; Yes), the post-processing controlling section 200 judges whether there is any information of specified roughening needing paper in the RAM 203 or not (Step S15).

If the post-processing controlling section 200 judges that the information of the specified roughening needing paper exists (Step S15; Yes), then the post-processing controlling section 200 reads the information of the specified roughening needing paper from the RAM 203 (Step S16), and judges whether the judging paper is the specified roughening needing paper or not (Step S17).

If the judging paper is the specified roughening needing paper (Step S17; Yes), then the post-processing controlling section 200 sets the judging paper to be the roughening needing paper (Step S13), and ends the present processing. Consequently, since the roughening processing can be executed to the paper of the paper type (specified roughening needing paper) received by the operation displaying section, the roughening processing can be executed to the paper desired by a user. Consequently, the binding strength according to the inclination of the user can be realized.

If the judging paper is not the specified roughening needing paper (Step S17; No), then the post-processing controlling section 200 judges whether there is no un-judged specified roughening needing paper or not (Step S18). If any un-judged specified roughening needing paper exists (Step S18; No), the post-processing controlling section 200 returns the processing to Step S16.

In the processing at Steps S16-S18, for example, if colored paper, fine quality paper, glossy paper, and coated paper are set as the specified roughening needing paper, then the post-processing controlling section 200 judges whether the type of the paper read at Step S16 among the plurality of paper types set as the specified roughening needing paper is coincident with the paper type of the judging paper or not. If both the paper types are coincident with each other, then the post-processing controlling section 200 judges that the judging paper is the specified roughening needing paper. If both the paper types are not coincident with each other, then the post-processing controlling section 200 returns the processing to Step S16, and reads another type of paper set as the specified roughening needing paper to be compared again.

If the post-processing controlling section 200 judges that the information of the specified roughening needing paper does not exist (Step S15; No), or if the post-processing controlling section 200 judges that there is no un-judged specified roughening needing paper (Step S18; Yes), then the post-processing controlling section 200 sets the judging paper to be the paper judged to the paper needing no roughening processing (hereinafter referred to as no-roughening needing paper) (Step S19), and ends the present processing.

As described above, according to the present first embodiment, the roughening processing is executed to paper based on a judgment result of the necessity of the roughening processing based on the type of paper (the prestored type of paper to be an object of the roughening processing (registered roughening needing paper) or the paper type of the paper received by the operation inputting section (specified roughening needing paper)). Consequently, it can be prevented to apply a large amount of adhesive to the paper that the adhesive permeates well, and it can be prevented to form a booklet having weak bond strength even if a user forgot to perform the setting of the roughening processing. Consequently, the binding strength of a booklet can be secured while suppressing the consumption of the adhesive.

In particular, since the roughening processing can be executed to the colored paper, the fine quality paper, the glossy paper, and the coated paper, all of which the adhesive does not permeate well, it can be prevented to form a booklet having weak bonding strength, and the biding strength of the booklet can be secured.

Moreover, an input instruction concerning whether to perform the roughening processing to the paper constituting a bundle of papers or not, or whether to perform the roughening processing to all papers or not, can be received with the binding setting screen at the time of executing the binding processing to produce a booklet by performing pasting to the side faces of the bundle of papers, and it can be judged whether the roughening processing is necessary or not based on the received input instruction. Consequently, the degree of freedom of the selection of the binding strength by a user can be improved.

### Second Embodiment

In the following, a second embodiment of the present invention will be described in detail with reference to the attached drawings.

Because the sectional configuration of the image forming system of the present second embodiment is the same as that of the image forming system equipped with the image forming apparatus and the sheet finisher of the first embodiment shown in FIG. 1, the diagrammatic representation and the description of the sectional configuration is omitted. Moreover, because also an example of the binding setting screen in the present second embodiment is the same as that of the binding setting screen of the first embodiment shown in FIG. 2, the diagrammatic representation and the description of the binding setting screen are omitted.

Moreover, because the block diagram showing the functional configuration of the image forming system of the present second embodiment is substantially the same as that of the functional configuration of the image forming system of the first embodiment shown in FIG. 3, the diagrammatic representation of the block diagram is omitted, and only different matters are described.

The post-processing controlling section 200 of the present second embodiment reads a roughening executing processing program according to the present second embodiment from the ROM 202, and reads various kinds of information, such as paper information and setting information of the binding strength received by the operation displaying section 30, from the RAM 203. If the types of paper constituting a bundle of papers are single when the automatic button B1 is depressed as the binding strength, then the post-processing controlling section 200 judges the necessity of roughening processing by the roughening section by the bundle of papers by the registered roughening needing paper stored in the ROM 202 or by the specified roughening needing paper stored in the RAM 203 based on the type of paper constituting the bundle of papers, and realizes the function as a controlling section to all papers constituting the bundle of papers based on the judgment result.

Next, the operation of the present second embodiment is described.

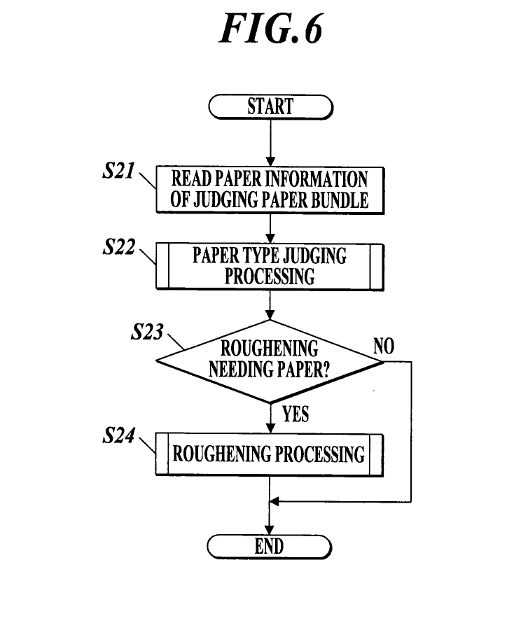

FIG. 6 shows the main flow chart of the roughening executing processing in the present second embodiment. Incidentally, the flow chart shown in FIG. 6 is supposed to be the processing to be executed by the post-processing controlling section 200 every formed booklet unit.

The post-processing controlling section 200 reads the paper information of a bundle of papers (hereinafter referred to as a judging paper bundle) to which a paper having reached the carry-in port, through which papers are conveyed from the image forming apparatus 1, belongs, from the RAM 203 based on a signal from the sensor provided in the carry-in port (Step S21), and executes the paper type judging processing to the judging paper bundle (Step S22).

The post-processing controlling section 200 judges whether the type of the papers of the judging paper bundle is the type of the paper judged to the paper needing the roughening processing by the roughening section 52 (hereinafter referred to as roughening needing paper) or not (Step S23). If the papers are not the roughening needing paper (Step S23; No), the post-processing controlling section 200 ends the present processing.

If the post-processing controlling section 200 judges that the paper type of the judging paper is the roughening needing paper (Step S23; Yes), then the post-processing controlling section 200 drives the roughening section 52 to perform the roughening processing to all of the papers constituting the judging paper bundle (Step S24), and ends the present processing.

Because the flow chart of the paper type judging processing in the main flow chart of the roughening executing processing shown in FIG. 6 is the same as the flow chart of the paper type judging processing of the first embodiment shown in FIG. 5 except that the type of paper to be compared with the registered roughening needing paper or the specified roughening needing paper is the type of paper of the judging paper bundle composed of a single paper type, the diagrammatic representation and description thereof are omitted.

As described above, according to the present second embodiment, substantially the same effects as those of the first embodiment can be obtained, and the necessity of the roughening processing can be judged by the bundle of papers if the types of papers constituting the bundle of papers are single.

### Third Embodiment

In the following, a third embodiment of the present invention will be described in detail with reference to the attached drawings.

Because the sectional configuration of the image forming system of the present third embodiment is the same as that of the image forming system equipped with the image forming apparatus and sheet finisher of the first embodiment shown in FIG. 1, the diagrammatic representation and description of the sectional configuration are omitted. Moreover, because an example of the binding setting screen in the present third embodiment is also the same as that of the binding setting screen of the first embodiment shown in FIG. 2, the diagrammatic representation and description of the example are omitted.

Moreover, because the block diagram showing the functional configuration of the image forming system of the present third embodiment is substantially the same as that of the functional configuration of the image forming system of the first embodiment shown in FIG. 3, the diagrammatic representation of the block diagram is omitted, and only the different matters are described.

The post-processing controlling section 200 of the present third embodiment reads the roughening executing processing program according to the present third embodiment from the ROM 202, and reads various kinds of information, such as paper information and the setting information of the binding strength received by the operation displaying section 30, from the RAM 203. If the types of the papers constituting a bundle of papers are mixed when the automatic button B1 is depressed as the binding strength, then the post-processing controlling section 200 realizes the function as a controlling section to judge whether a conveyed paper needs the roughening processing by the roughening section 52 or not by the registered roughening needing paper stored in the ROM 202 or by the specified roughening needing paper stored in the RAM 203 based on the type of the paper, and to cause the roughening section 52 to execute roughening processing to a predetermined number of papers (second papers) adjoining the first paper (judged that the roughening processing by the roughening section 52 is necessary) and judged that the roughening processing by the roughening section 52 is necessary.

Next, the operation of the present third embodiment is described.

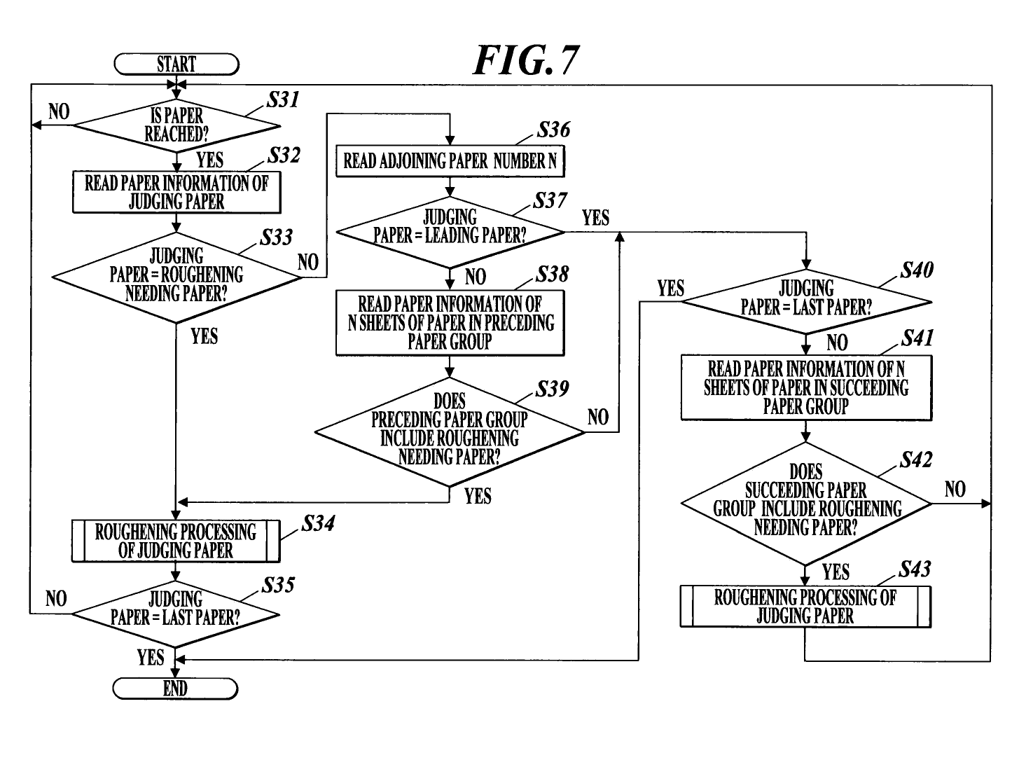

FIG. 7 shows a flow chart of the roughening executing processing in the present third embodiment. Incidentally, the flow chart shown in FIG. 7 is supposed to be the processing to be executed by the post-processing controlling section 200 every formed booklet unit.

The post-processing controlling section 200 judges whether a paper has reached the carry-in port, to which papers are conveyed from the image forming apparatus 1, or not based on a signal from the sensor provided in the carry-in port (Step S31). If no papers have reached (Step S31; No), the prost-processing controlling section 200 returns the processing to Step S31.

If any paper has reached the carry-in port (Step S31; Yes), then the post-processing controlling section 200 reads the paper information of the paper (judging paper) from the RAM 203 (Step S32), and executes the paper type judging processing to the judging paper to judge whether the judging paper is the roughening needing paper or not (Step S33). Incidentally, because the paper type judging processing at Step S33 executes the paper type judging processing of the first embodiment shown in FIG. 5, the diagrammatic representation and description of the paper type judging processing are omitted.

If the judging paper is the roughening needing paper (Step S33; Yes), then the post-processing controlling section 200 drives the roughening section 52 to perform roughening processing to the judging paper (Step S34), and judges whether the judging paper is the last paper among the plurality of papers constituting the bundle of papers or not (Step S35). If the judging paper is not the last paper (Step S35; No), then the post-processing controlling section 200 returns the processing to Step S31. If the judging paper is the last paper (Step S35; Yes), then the post-processing controlling section 200 ends the present processing.

If the judging paper is not the roughening needing paper (Step S33; No), then the post-processing controlling section 200 reads the number of predetermined papers adjoining the judging paper (hereinafter referred to as adjoining paper number N) (Step S36).

The post-processing controlling section 200 judges whether the judging paper is a leading paper of the bundle of papers (leading paper) or not based on the paper information of the judging paper (Step S37). If the judging paper is not the leading paper (Step S37; No), then the post-processing controlling section 200 reads the paper information of each of the papers of the adjoining paper number N conveyed before the paper (hereinafter, referred to as a preceding paper group) (Step S38).

The post-processing controlling section 200 executes the paper type judging processing to each paper constituting the preceding paper group to judge whether the preceding paper group includes any sheets of roughening needing paper or not (Step S39). Incidentally, because the paper type judging processing to each paper at Step S39 executes the paper type judging processing of the first embodiment shown in FIG. 5 to each paper, the diagrammatic representation and description of the paper type judging processing are omitted.

If the preceding paper group includes some sheets of roughening needing paper (Step S39; Yes), then the post-processing controlling section 200 advances the processing to Step S34.

If the judging paper is a leading paper of the bundle of papers (Step S37; Yes), or if the preceding paper group does not include any sheets of roughening needing paper (Step S39; No), then the post-processing controlling section 200 judges whether the judging paper is the last paper of the bundle of papers (last paper) or not based on the paper information of the judging paper (Step S40). If the judging paper is the last paper (Step S40; Yes), then the post-processing controlling section 200 ends the present processing.

If the judging paper is not the last paper of the bundle of papers (Step S40; No), then the post-processing controlling section 200 reads the paper information of each paper of the adjoining paper number N conveyed succeedingly to the paper (hereinafter, referred to as a succeeding paper group) (Step S41).

The post-processing controlling section 200 executes the paper type judging processing to each paper constituting the succeeding paper group to judge whether the succeeding paper group includes any sheets of roughening needing paper or not (Step S42). Incidentally, because the paper type judging processing to each paper at Step S41 executes the paper type judging processing of the first embodiment shown in FIG. 5 to each paper, the diagrammatic representation and description of the paper type judging processing are omitted.

If the succeeding paper group includes some sheets of roughening needing paper (Step S42; Yes), then the post-processing controlling section 200 drives the roughening section 52 to perform the roughening processing to the judging paper (Step S43), and returns the processing to Step S31.

If the succeeding paper group does not include any roughening needing paper (Step S42; No), then the post-processing controlling section 200 returns the processing to Step S31.

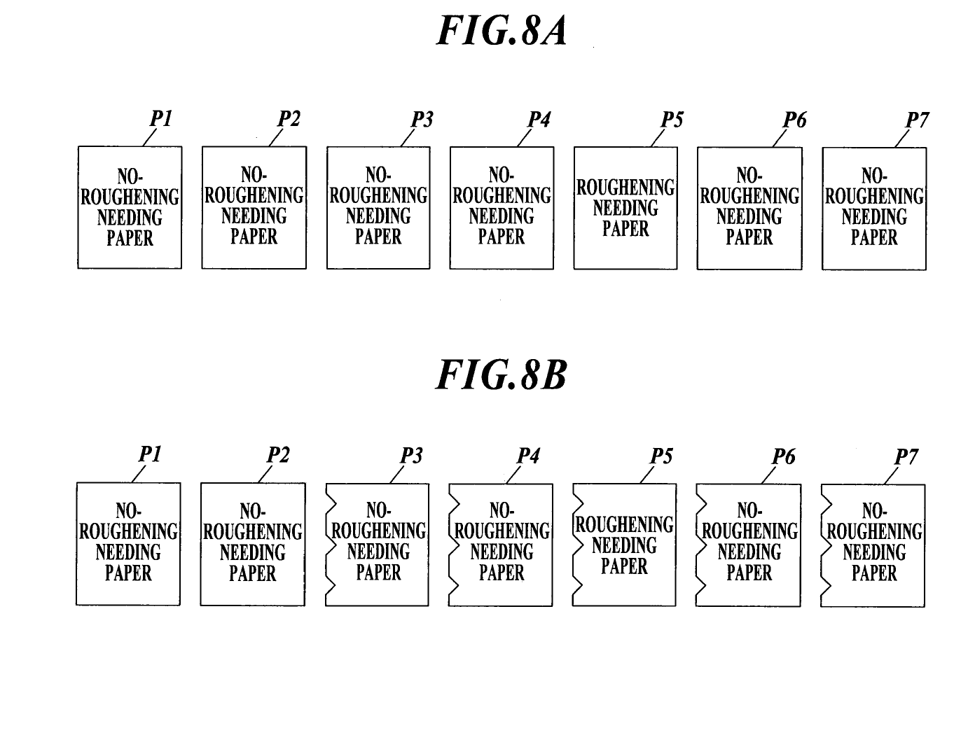

FIG. 8A shows an image view of paper as judging results (roughening needing paper or no-roughening needing paper) judged by the paper type judging processing based on the paper information of each paper, and FIG. 8B shows an image view of each paper constituting a bundle of papers after the execution of the roughening executing processing in the present third embodiment.

Incidentally, the papers that have received the roughening processing are the papers P3-P7 having notch parts of V configurations in one end part of each of them in FIG. 8B.

As shown in FIG. 8A, an example of the case of paying attention to the paper P3 as the judging paper in the case where the papers P1-P4, P6, and P7 are no-roughening needing paper and the paper P5 is the roughening needing paper, and in the case where the number of sheets N of the adjoining paper is set to two, is described.

Since the paper P3 is the no-roughening needing paper and is not the leading paper, the paper information of adjoining two sheets of preceding paper group (paper P1 and P2) is read, and the paper type judging processing is executed to each paper constituting the preceding paper group.

Since all sheets of the preceding paper group are the no-roughening needing paper, that is, since no roughening needing paper is included and the paper P3 is not the last paper, the paper information of adjoining two papers in the succeeding paper group (paper P4 and P5) are read, and the paper type judging processing is executed to each paper constituting the succeeding paper group.

Since the paper P5 included in the succeeding paper group is the roughening needing paper, that is, since the succeeding paper group includes the roughening needing paper, the roughening processing is executed to the paper P3.

As described above, according to the present third embodiment, the substantially same effects as those of the first embodiment can be obtained, and the roughening processing can be executed to the predetermined number of papers that have been judged that the roughening processing is not necessary and adjoin the paper that has been judged that the roughening processing is necessary by the post-processing controlling section 200 in the case where the types of the papers constituting the bundle of papers are mixed. Then, the binding strength of a booklet can be made to be strong while attaining the suppression of an adhesive.

### Fourth Embodiment

In the following a fourth embodiment of the present invention will be described in detail with reference to the attached drawings.

Because the sectional configuration of the image forming system in the present fourth embodiment is the same as that of the first embodiment equipped with the image forming apparatus and sheet finisher shown in FIG. 1, the diagrammatic representation and description of the sectional configuration are omitted. Moreover, because an example of the binding setting screen of the present fourth embodiment is also the same as that of the first embodiment shown in FIG. 2, the diagrammatic representation and description of the example are omitted.

Moreover, because the block diagram showing the functional configuration of the image forming system of the present fourth embodiment is substantially the same as that of the functional configuration of the image forming system of the first embodiment shown in FIG. 3, the diagrammatic representation of the block diagram is omitted, and only different matters are described.

The post-processing controlling section 200 of the present fourth embodiment reads the roughening executing processing program according to the present fourth embodiment from the ROM 202, and reads various kinds of information, such as paper information and setting information of the binding strength received by the operation displaying section 30, from the RAM 203. If the types of papers constituting a bundle of papers are mixed when the automatic button B1 is depressed as the binding strength, then the post-processing controlling section 200 judges whether a conveyed paper needs the roughening processing by the roughening section 52 or not by the registered roughening needing paper stored in the ROM 202 or the specified roughening needing paper stored in the RAM 203 based on the type of the paper. Moreover, if the papers that have been judged that the roughening processing is necessary by the roughening section 52 continue by a predetermined number of papers, then the post-processing controlling section 200 realizes the function as a controlling section to forbid the roughening processing by the roughening section 52 to the papers that adjoin the continuing papers and have been judged that the roughening processing is not necessary.

Next, the operation of the present fourth embodiment is described.

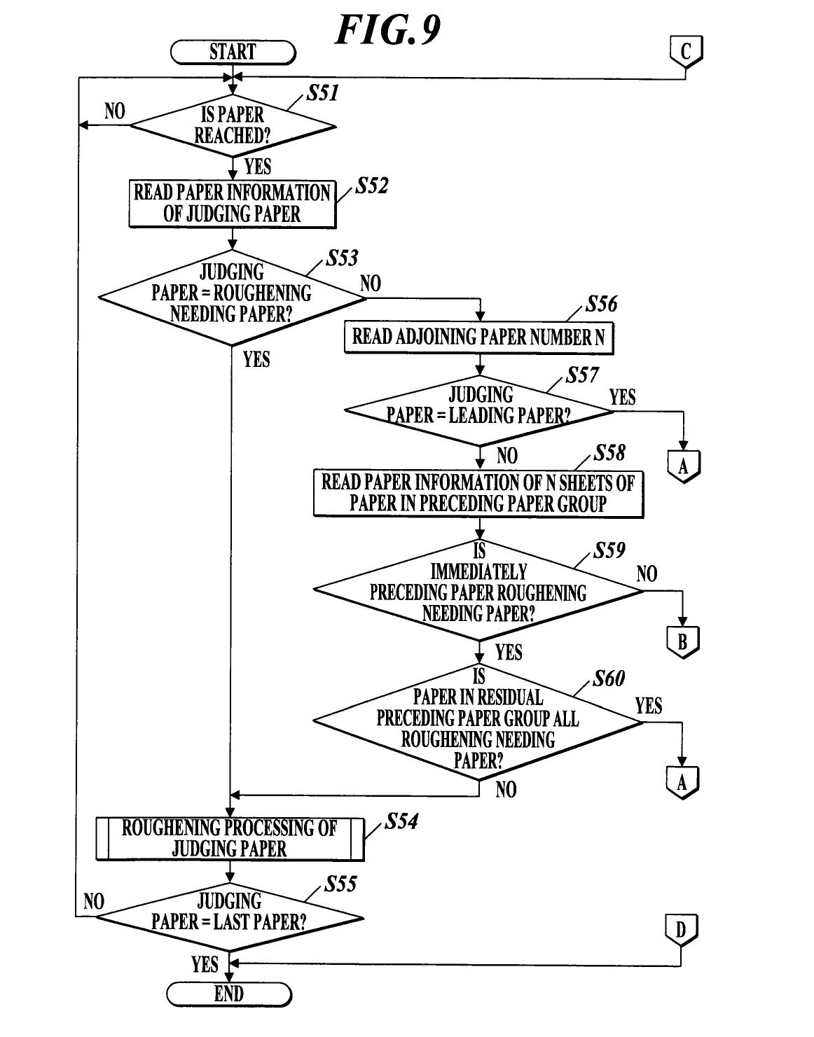

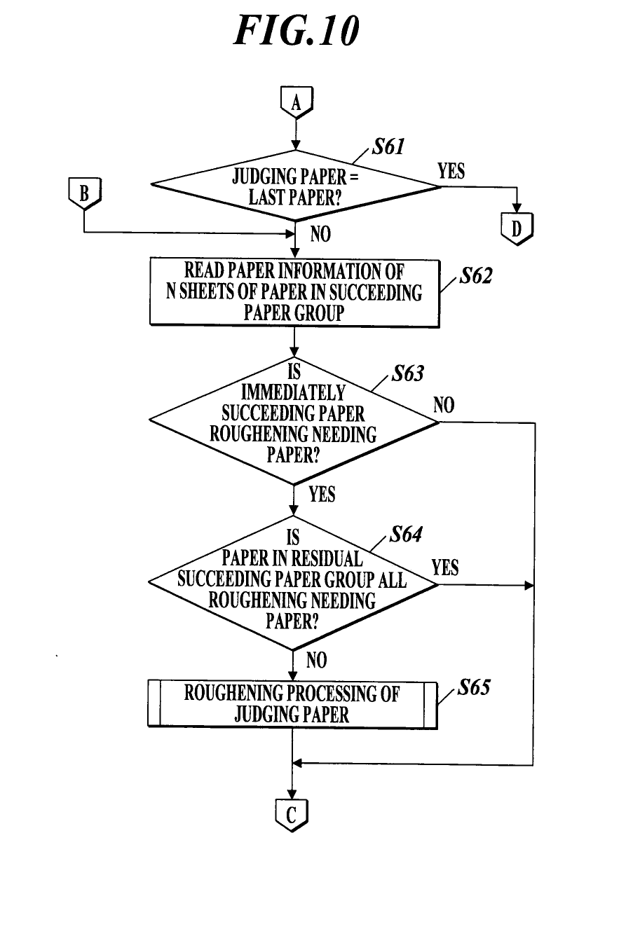

FIGS. 9 and 10 show the flow charts of the roughening executing processing in the present fourth embodiment. Incidentally, the flow charts shown in FIGS. 9 and 10 are supposed to be the processing to be executed by the post-processing controlling section 200 every formed booklet unit.

Because the processing at Steps S51-S55 is the same as that at Step S31-S35 in the flow chart of the roughening executing processing of the third embodiment shown in FIG. 7, the description of the processing is omitted.

If the judging paper is not the roughening needing paper (Step S53; No), then the post-processing controlling section 200 reads the predetermined number of papers adjoining the judging paper (hereinafter referred to as an adjoining paper number N) (Step S56).

The post-processing controlling section 200 judges whether the judging paper is a leading paper of a bundle of papers (leading paper) or not based on the paper information of the judging paper (Step S57). If the judging paper is not the leading paper (Step S57; No), then the post-processing controlling section 200 reads the paper information of each of papers of the adjoining paper number N that have been conveyed before the paper (hereinafter referred to as a preceding paper group) (Step S58).

The post-processing controlling section 200 executes the paper type judging processing to a paper conveyed just before the judging paper (immediately preceding paper) to judge whether the immediately preceding paper is the roughening needing paper or not (Step S59).

If the immediately preceding paper is the roughening needing paper (Step S59; Yes), then the post-processing controlling section 200 executes the paper type judging processing to each paper constituting the preceding paper group (residual preceding paper group) except for the immediately preceding paper to judge whether all of the papers included in the residual preceding paper group are the roughening needing paper or not (Step S60).

Incidentally, because the paper type judging processing at Steps S59 and S60 to each paper executes that of the first embodiment shown in FIG. 5 to each paper, the diagrammatic representation and description of the paper type judging processing are omitted.

If any of the papers included in the residual preceding paper group is the no-roughening needing paper (Step S60; No), then the post-processing controlling section 200 advances the processing to Step S54.

If the judging paper is the leading paper (Step S57; Yes), or if all of the papers included in the residual preceding paper group are the roughening needing paper, that is, if N sheets of roughening needing paper continue before the judging paper (Step S60; Yes), then the post-processing controlling section 200 judges whether the judging paper is the last paper of the bundle of papers (last paper) or not based on the paper information of the judging paper (Step S61) If the judging paper is the last paper (Step S61; Yes), then the post-processing controlling section 200 ends the present processing.

If the immediately preceding paper is not the roughening needing paper (Step S59; No), or if the judging paper is not the last paper (Step S61; No), then the post-processing controlling section 200 reads the paper information of each of paper of the adjoining paper number N that have been conveyed succeedingly to the paper (hereinafter referred to as a succeeding paper group) (Step S62).

The post-processing controlling section 200 executes the paper type judging processing to the paper (immediately succeeding paper) conveyed immediately succeedingly to the judging paper to judge whether the immediately succeeding paper is the roughening needing paper or not (Step S63).

If the immediately succeeding paper is the roughening needing paper (Step S63; Yes), then the post-processing controlling section 200 executes the paper type judging processing to each paper constituting the succeeding paper group (residual succeeding paper group) except for the immediately succeeding paper to judge whether all of the papers included in the residual succeeding paper group are the roughening needing paper or not (Step S64).

Incidentally, because the paper type judging processing to each of the papers at Steps S63 and S64 executes the paper type judging processing in the first embodiment shown in FIG. 5 to each paper, the diagrammatic representation and description of the paper type judging processing are omitted.

If the immediately succeeding paper is not the roughening needing paper (Step S63; No), or if all of the papers included in the residual succeeding paper group are the roughening needing paper, that is, if N sheets of roughening needing paper continue succeedingly to the judging paper (Step S64; Yes), then the post-processing controlling section 200 returns the processing to Step S51.

If any of the papers included in the residual succeeding paper group is the no-roughening needing paper (Step S64; No), then the post-processing controlling section 200 drives the roughening section 52 to perform the roughening processing to the judging paper (Step S65), and returns the processing to Step S51.

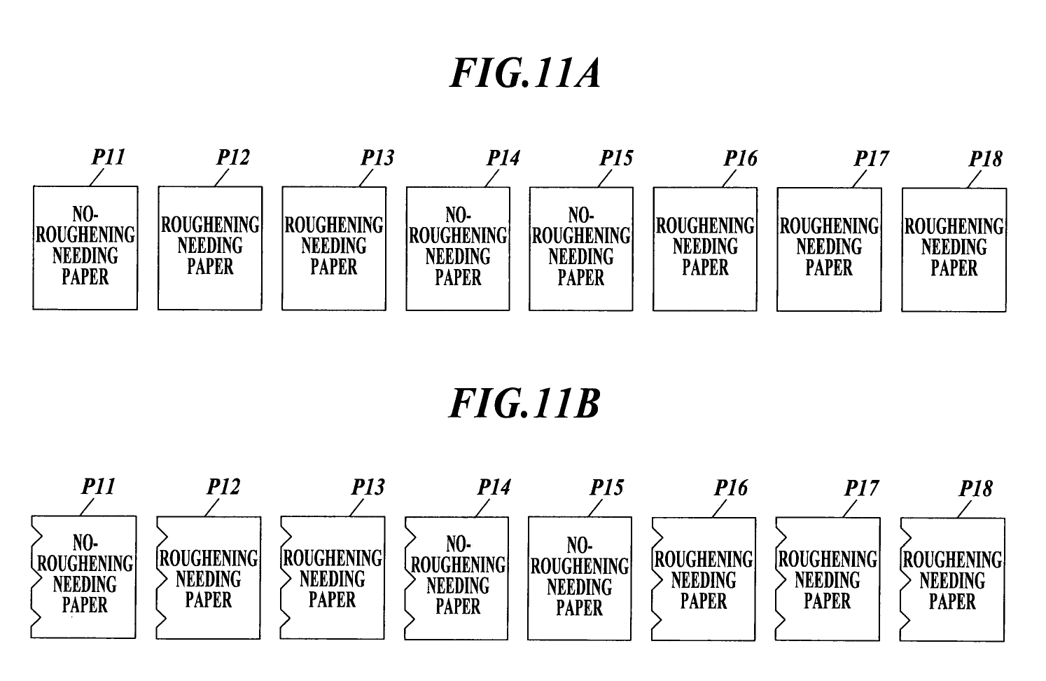

FIG. 11A shows an image view of the papers as the judgment results (roughening needing paper or no-roughening needing paper) of the judgment by the paper type judging processing based on the paper information of each paper, and FIG. 11B shows an image view of each of the papers constituting the bundle of papers after the execution of the roughening processing in the present fourth embodiment. Incidentally, the papers having received the roughening processing are the papers P11-P14 and P16-P18 each having notch parts formed in V configurations in its one end part.

As shown in FIG. 11A, an example of the case of paying attention to the paper P14 as the judging paper in the case where the papers P11, P14, and P15 are the no-roughening needing paper and the papers P12, P13, and P16-P18 are the roughening needing paper, and in the case where the number N of the sheets of adjoining paper is set to three, is described.

Since the paper P14 is the no-roughening needing paper and is not the leading paper, the paper information of adjoining three papers in the preceding paper group (paper P11-P13) is read. First, the paper type judging processing is executed to the immediately preceding paper (paper P13), and the paper type judging processing is executed to the residual preceding paper group (paper P11 and P12) because the immediately preceding paper is the roughening needing paper. Since the paper P11 is the no-roughening needing paper between the residual preceding paper group (paper P11 and P12) all of the papers in the residual preceding paper group are not the roughening needing paper. That is, since three sheets of roughening needing paper do not continue before the judging paper (paper P14), the roughening processing is led to be executed to the judging paper (paper P14).

As shown in FIG. 11A, an example of the case of paying attention to the paper P15 as the judging paper in the case where the papers P11, P14, and P15 are the no-roughening needing paper and the papers P12, P13, and P16-P18 are the roughening needing paper, and in the case where the number N of sheets of adjoining paper is set to three, is described.

Since the paper P15 is the no-roughening needing paper and is not the leading paper, the paper information of three adjoining papers in the preceding paper group (paper P12-P14) is read. First, the paper type judging processing is executed to the immediately preceding paper (paper P14), and the paper information of adjoining three papers in the succeeding paper group (paper P16-P18) is read because the immediately preceding paper is the no-roughening needing paper.

Then, the paper type judging processing is executed to the immediately succeeding paper (paper P16), and the paper type judging processing is executed to the residual succeeding paper group (paper P17 and P18) because the immediately succeeding paper is the roughening needing paper.

Since all of the papers in the residual succeeding paper group (paper P17 and P18) are the roughening needing paper, that is, since thee sheets of roughening needing paper continue succeedingly to the judging paper (paper P15), the roughening processing to the judging paper (paper P15) is led to be forbidden.

As described above, according to the present fourth embodiment, substantially the same effects as those of the first embodiment can be obtained. Furthermore, in the case where the bundle of papers includes a plurality of types of papers and the papers that have been judged that the roughening processing is necessary continue by a predetermined number, the roughening processing can be forbidden to the papers that adjoin the continuing papers and have been judged that the roughening processing is not necessary on the supposition that the binding strength is secured. Consequently, the suppression of an adhesive can be attained while securing the binding strength of a booklet.

Moreover, the present invention is not limited to the content of the embodiment, but the content of the embodiment can be suitably changed without departing the sprit and the scope of the present invention.

In the binding apparatus, the sheet finisher, and the image forming system, since the roughening processing is executed to paper based on the judging result of the necessity of the roughening processing based on the type of the paper, it can be prevented to apply a large amount of adhesive to a paper that the adhesive permeates well, and it can be prevented to form a booklet having weak binding strength owing to insufficient bonding force between papers even if a user forgot to perform the setting of the roughening processing. Consequently, the binding strength of a booklet can be secured while attaining the suppression of the consumption of adhesives.

Furthermore, since the roughening processing can be executed to colored paper, fine quality paper, glossy paper, and coated paper, all of which an adhesive does not permeate well, the formation of a booklet having weak binding strength owing to insufficient biding force between papers can be prevented, and the binding strength of the booklet can be secured.

Furthermore, the roughening processing can be executed to the previously stored type of paper of an object of the roughening processing.

Furthermore, the roughening processing can be executed to the received paper type of paper.

Furthermore, if the types of papers constituting a bundle of papers are single, then the necessity of the roughening processing can be judged by the bundle of papers.

Furthermore, in the case where the types of papers constituting a bundle of papers are mixed, the roughening processing can be executed to a predetermined number of papers that are judged that the roughening processing is not necessary and adjoin a paper judged that the roughening processing is necessary, and consequently the binding strength of a booklet can be made to be strong while achieving the suppression of adhesives.

Furthermore, if the types of papers constituting a bundle of papers are mixed, and if the papers judged that the roughening processing is necessary continue by a predetermined number of papers, then the roughening processing can be forbidden to the papers that have been judged that the roughening processing is not necessary and adjoin the continuing papers on the supposition that the binding strength is secured, and consequently the suppression of adhesives can be attained while securing the binding strength of a booklet.

Furthermore, when binding processing to produce a booklet by performing pasting to a side face of a bundle of papers is executed, it is possible to receive an input instruction concerning whether to perform the roughening processing to the papers constituting the bundle of papers or not, or whether to perform the roughening processing to all papers or not, and to judge whether the roughening processing is necessary or not based on the received input instruction. Consequently, the degree of freedom of selecting the binding strength by a user can be improved.

The entire disclosure of Japanese Patent Application No. 2007-266697 filed on Oct. 12, 2007 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A binding apparatus comprising:
a booklet producing section to produce a booklet by performing pasting onto a side face of a bundle of papers;
a roughening section to perform roughening processing to one end part to which the pasting to the papers is performed; and
a controlling section to judge whether the roughening processing by the roughening section is necessary or not based on a type of the paper before causing the booklet producing section to produce the booklet, and to cause the roughening section to execute the roughening processing to the paper when the controlling section judges that the roughening processing is necessary.

2. The binding apparatus of claim 1, wherein the controlling section causes the roughening section to execute the roughening processing when the type of the paper is any of colored paper, fine quality paper, glossy paper, and coated paper.

3. The binding apparatus of claim 1, further comprising a storing section to pre-store a type of the paper to which the roughening processing is executed by the roughening section, wherein the controlling section judges whether the roughening processing by the roughening section is necessary or not based on the type of the paper stored in the storing section and causes the roughening section to execute the roughening processing to the paper when the type of the paper judged by the controlling section is coincident with the type of the paper pre-stored in the storing section.

4. The binding apparatus of claim 1, further comprising a first setting section to set the type of the paper to which the roughening processing is executed by the roughening section, wherein the controlling section judges whether the roughening processing by the roughening section is necessary or not based on the type of the paper set by the first setting section and causes the roughening section to execute the roughening processing to the paper when the type of the paper judged by the controlling section is coincident with the type of the paper set by the first setting section.

5. The binding apparatus of claim 1, wherein the controlling section judges whether the roughening processing by the roughening section is necessary or not based on a type of papers constituting the bundle of the papers and causes the roughening section to execute the roughening processing to all papers constituting the bundle of papers when the controlling section judges that the roughening processing is necessary and the type of papers constituting the bundle of papers is single.

6. The binding apparatus of claim 1, wherein the controlling section causes the roughening section to execute the roughening processing to first paper judged that the roughening processing by the roughening section is necessary and to a predetermined number of second papers adjoining the first paper and judged that the roughening processing is not necessary when the bundle of papers includes a plurality of types of papers.

7. The binding apparatus of claim 1, wherein, if first papers judged that the roughening processing by the roughening section is necessary are continuously output by a predetermined number of papers, the controlling section forbids the roughening processing by the roughening section to a second paper judged that the roughening processing is not necessary and adjoining the continuously output first papers when the bundle of papers includes a plurality of types of papers.

8. The binding apparatus of claim 1, further comprising a second setting section to receive an input instruction of whether to perform the roughening processing to papers constituting the bundle of papers or not, or whether to perform the roughening processing to all papers or not, at the time of executing the binding processing to produce the booklet by performing the pasting to the side face of the bundle of papers, wherein the controlling section judges whether the roughening processing by the roughening section is necessary or not based on the input instruction received by the second setting section and causes the roughening section to execute the roughening processing when the controlling section judges the roughening processing is necessary.

9. A sheet finisher to perform post-processing to papers, comprising a binding apparatus of claim 1.

10. An image forming system comprising:
an image forming apparatus to form images on papers; and
a binding apparatus of claim 1, the binding apparatus performing binding processing to the papers on which the images are formed by the image forming apparatus.
